(19) United States
(12) Patent Application Publication
(10) Pub. No.: US 2019/0223446 A1
(43) Pub. Date: Jul. 25, 2019

(54) METHODS FOR SEQUESTERING CARBON OF ORGANIC MATERIALS

(71) Applicant: David EICHLER, Beer-Sheva (IL)

(72) Inventor: David EICHLER, Beer-Sheva (IL)

(21) Appl. No.: 16/371,226

(22) Filed: Apr. 1, 2019

Related U.S. Application Data
(63) Continuation of application No. 15/175,274, filed on Jun. 7, 2016.

(51) Int. Cl. A01N 59/08; B09B 5/00; B09B 3/00; A23L 2/44

(52) U.S. Cl. CPC A01N 59/08; B09B 5/00; A23V 2002/00; A23L 2/44; B09B 3/00

(57) ABSTRACT

Methods and systems for inhibiting biodegradation of biodegradable organic material are provided. In particular, methods for the treatment and storage of organic material (e.g. waste, vegetation) in hypersaline environment, including mixing with oceanwater, concentration to hypersalinity and maintenance of carbonaceous organic waste in the hypersaline environment are provided.

### RELATED APPLICATION

This application is a continuation of U.S. patent application Ser. No. 15/175,274 filed on Jun. 7, 2016, the contents of which are incorporated herein by reference in their entirety.

### FIELD AND BACKGROUND OF THE INVENTION

The human consumption of fossil fuels in the past century has been closely associated with an excess of carbon dioxide and other greenhouse gases in the atmosphere, which may threaten our climate and environment. At present, more than 10 percent of all carbon dioxide released into the atmosphere is due to human consumption of fossil fuels, including natural gas released and burned at well heads. Additional sources of anthropogenic carbon dioxide include cement production and soil depletion.

There is some suspicion that this is causing significant global warming as well as altering ecological balances in other ways, such as ocean acidification. The possibility exists that global warming can feed on itself and trigger positive feedback loops in the greenhouse gas-climate connection, possibly setting off an accelerated or runaway greenhouse effect. Increased humidity, increased methane escape through melting polar ice, and increased release of carbon dioxide (CO₂) from oceans as they warm (and thus decrease their CO₂ solubility) are a few examples of possible positive feedback loops in the greenhouse gas-global warming scenario.

There has been much discussion, therefore, of plans for capture and sequestration of CO₂, whereby CO₂ released by industrial plants would be captured at the plant that produces it and then stored underground or undersea for a duration (time horizon) of at least 100 years, though longer horizons are preferable and arguably necessary to satisfy moral concerns for the fate of future generations (see Carbon Capture and Storage Association-CCSA-website).

The potential problems with this approach at present are its expense and questionable environmental efficacy. The oft quoted, probably optimistic cost of one cent per kilowatt hour for carbon dioxide sequestration at coal-fueled power plants translates to 90 dollars per ton of carbon burned, which is the equivalent of 30 dollars per ton of CO₂ (1 kilowatt hour=3.6×10⁶ joules=3600 kilojoules; 1 gram carbon burned releases 9 kiloCal or about 39.2 kilojoules, so that 1 kilowatt hour has the carbon equivalent of approximately 3600/40 or 90 gram of carbon. 1 metric ton of carbon=10⁶ grams, providing about 1.1×10⁴ kilowatt hours. Sequestration of CO₂ at 1 cent/kilowatt hour gives a cost of about 110$ per metric ton of carbon, or about 30$ per metric ton of CO₂, since the atomic weight of Carbon [12 g/mol] is 0.2727 the molecular weight of CO₂ [44 g/mol]).

Calculated on the basis of about 2,000 million metric tons of CO₂ emitted from electricity generation each year in the US alone, the “one cent per kilowatt hour” becomes about 60 billion dollars spent on CO₂ sequestration per year in the US alone. In addition, dumping carbon dioxide into the oceans is ecologically risky. Despite receiving large amounts of public attention and developmental funding, carbon dioxide sequestration at power plants is not currently being carried out on a large scale. Economic incentive for doing it would seem to require a market value of carbon credits in the neighborhood of 30 dollars per ton of CO₂.

There are also socioeconomic reasons to doubt that CO₂ sequestration could be carried out in a totally reliable manner for a noncontroversial length of time. Temporary and/or unreliable CO₂ sequestration is probably cheaper than secure sequestration, and assuring that the sequestration has been done in adequate, acceptable fashion, especially if the CO₂ is stored deep underground in geologically obscure and remote sites, would be technically difficult and susceptible to political corruption and even organized crime. Forestation captures CO₂ from the atmosphere and stores the carbon in living trees, but the trees all eventually die and decay, so that this form of carbon sequestration is, by itself, inevitably temporary.

This is one of the reasons the EU has given for rejecting forestation as a legitimate source of carbon credits.

### The Biosphere

The biosphere contains only about 12.5 kilograms of biomass, on the average, per square meter of dry land. Most of this biomass is concentrated in tropical forests where the storage capacity of biomass within the ecosystem is nearly saturated by competition for sunlight. Even in the wildly optimistic scenario that the overall capacity of the biosphere could be doubled through human effort, this added capacity would fill up within 125 years or so, given the present world-wide consumption of fossil fuel on the order of 10 billion tons per year.

The widely voiced concern over anthropogenic green house gas emission has obscured the fact that most of the carbon dioxide being released into the atmosphere at present is still being released via natural means. Only about 10 to 15 percent of the current CO₂ emission into the atmosphere is anthropogenic, the rest is due to decay of natural biomass. The rise in atmospheric carbon dioxide is not because of the predominance of fossil fuel consumption relative to the metabolism of living things, but rather because the contribution of fossil fuels is a recent development over the time scale of the planet's ecology, and the balance that has been established over most of the planet's history has therefore been upset. Conversely, almost all biomass, including human waste, decays into carbon dioxide and other greenhouse gases if left to its natural fate, and certainly if destined for combustion. The known fossil fuel reserves on the planet represent anomalous (less than one part in a million), preserved biomass that, through a series of rare events and circumstances, somehow escaped the nearly universal fate of most biomass (decay and conversion to water and CO₂).

Some methods for sequestering biomass carbon have been proposed—US Patent Publications 20100257775 to Cheiky, M, and 20130213101 to Shearer et al teach converting biomass into inert carbon aggregates by pyrolyzing the biomass into biochar and filtrate carbon and compacting and compressing the carbon into coal, which can then be stored in abandoned mines. Many methods (see, for example US Patent Publication No. 20120289440 to Pollard et al) teach the pyrolysis of biomass along with bitumen from oil sands, and the storage of the biochar to sequester biomass carbon. Some methods rely upon the long flow pathways of deep ocean masses to sequester carbon for thousands, perhaps millions of years at the seabed.

US Patent Publication 20100145716 to Zeng teaches the burial of timber in soil, creating partial anaerobic conditions to stall decay and greenhouse gas emission. US Patent Publication No. 20040161364 to Carlson teaches the sequestration of carbon in oceans, lakes or man-made tanks or lakes by growing, and then killing or destroying aquatic plant biomass (e.g. with herbicides, growth inhibitors, etc) and allowing it to sink. Also conceived is entrapment of atmospheric carbon by enhancement of the plant biomass growth prior to the killing or destroying. US Patent Publication No. 20070028848 to Lutz also teaches carbon sequestration in aqueous environments by introducing aquatic organisms (preferably of a higher trophic level) into a body of water, growing the organisms until the biomass sinks into ocean depths. U.S. Pat. No. 5,992,089 to Jones et al teaches enhancing phytoplankton growth and photosynthesis by providing nitrogen at mixed levels of the ocean, and relying on ocean currents to remove dead plankton and organic material to ocean depths.

### SUMMARY OF THE INVENTION

According to an aspect of some embodiments of the present invention there is provided a method of inhibiting biodegradation of a biodegradable organic material comprising: a) contacting the organic material with a solution comprising a cytotoxic agent or characteristic, b) concentrating the solution, thereby enhancing cytotoxicity of the solution and c) maintaining the biodegradable organic material within the concentrated cytotoxic solution, thereby inhibiting biodegradation of the organic material.

According to some embodiments of the invention the cytotoxic characteristic is selected from the group consisting of alkalinity, acidity, radiation, and hyper- or hypo-osmolarity.

According to an aspect of some embodiments of the present invention there is provided a method of inhibiting biodegradation of a biodegradable organic material comprising: a) contacting the organic material with a salt solution, b) concentrating the salt solution, thereby producing a high salt environment and c) maintaining the biodegradable organic material within the high salt environment, thereby inhibiting biodegradation of the organic material.

According to an aspect of some embodiments of the present invention there is provided a method of inhibiting the biodegradation of biodegradable organic material comprising: a) contacting the organic material with an effective amount of a solid salt, thereby producing a high salt environment and b) maintaining the biodegradable organic material within the high salt environment, thereby inhibiting biodegradation of the organic material.

According to an aspect of some embodiments of the present invention there is provided a system for inhibiting biodegradation of biodegradable organic material comprising: a) an evaporation pan; b) a saline solution source; c) a source of biodegradable organic material and d) a means for concentrating the saline solution in the evaporation pan, wherein the evaporation pan is designed to allow contact of the biodegradable organic material with the saline solution and wherein the means for concentrating the saline solution is designed to allow concentrating the saline solution in the evaporation pan while maintaining contact with the biodegradable organic material.

According to some embodiments of the invention the evaporation pan comprises a layer of solid or semisolid sealing material covering biodegradable organic material comprised within a hypersaline environment.

According to some embodiments of the invention the evaporation pan is comprised within or near a saline or hypersaline lake.

According to some embodiments of the invention the evaporation pan is comprised within or near a sea coastline.

According to some embodiments of the invention the evaporation pan is located below sea level.

According to some embodiments of the invention the salt is sodium chloride (NaCl), the salt solution is a saline solution and the high salt environment is a hyper-saline environment.

According to some embodiments of the invention the concentrating is effected by a method selected from the group consisting of evaporation, leaching, supplementation of the cytotoxic agent and reverse osmosis.

According to some embodiments of the invention the biodegradable organic material is selected from the group consisting of municipal waste, industrial waste, hospital waste, agricultural waste and live and dead vegetation.

According to some embodiments of the invention the biodegradable organic material is in a liquid form, in a solid form or in a sludge and or slurry.

According to some embodiments of the invention the cytotoxic environment is a liquid cytotoxic environment or a solid cytotoxic environment.

According to some embodiments of the invention the high salt environment is a liquid high salt environment or a solid high salt environment.

According to some embodiments of the invention the biodegradable organic material is in direct contact with the cytotoxic solution.

According to some embodiments of the invention the biodegradable organic material is in direct contact with the high salt or saline solution.

According to some embodiments of the invention, the method further comprising covering the biodegradable organic material with a solid or semisolid sealing material.

According to some embodiments of the invention the solid or semisolid sealing material is selected from the group consisting of clay, ice, plastic, wood, glass and salt.

According to some embodiments of the invention the biodegradable organic material is pre-treated with a cytotoxic agent or cytotoxic process prior to or following step (a) and/or (b).

According to some embodiments of the invention the cytotoxic agent or cytotoxic process comprises heating, cooling, extremes of pH, disinfection, radiation, salinity and antibacterial inoculation.

According to some embodiments of the invention wherein volume of the biodegradable organic material is reduced prior to the sealing.

According to some embodiments of the invention step (a) or step (b) further comprises contacting the biodegradable organic material with a photoabsorbent pigmented material.

According to some embodiments of the invention concentrating the salt solution in step (b) to high salt comprises concentrating to a salt concentration of at least 2% (w/vol).

According to some embodiments of the invention the concentrating is achieved by evaporation.

According to some embodiments of the invention the concentrating is effected by solar energy.

According to some embodiments of the invention the salt concentration of the hypersaline environment is in the range of greater than 3.5% to 35% (w/v).

According to some embodiments of the invention the high salt environment comprises crystalline or granulated salt.

According to some embodiments of the invention steps a)-c) are performed in an evaporation pan.

According to some embodiments of the invention the upper surface of the evaporation pan comprises a layer of solid or semisolid sealing material covering biodegradable organic material comprised within a hypersaline environment.

According to some embodiments of the invention the contacting is performed below sea level.

According to some embodiments of the invention the contacting is performed at or above sea level.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SPECIFIC EMBODIMENTS OF THE INVENTION

Only about 10 to 15 percent of the current CO₂ emission into the atmosphere is anthropogenic, the rest is due to decay of natural biomass. As storing gaseous carbon dioxide is problematic, storage of liquid or solid carbonaceous material other than fossil fuel may become increasingly imperative, and such storage needs to occur in a form where (a) it does not decay or decompose into CO₂ or other greenhouse gases; (b) it can be stored in amounts per unit area that are greater, even much greater than the biospheric average for biomass; and (c) it is less expensive in energy expenditure than what would be available from the carbonaceous material that is stored. The higher (or deeper) carbonaceous material can be piled and stored without significant decay over a significant time horizon, the less area need be devoted to storing carbon in order to offset fossil fuel burning.

This suggests a new approach to carbon credits, in which they are earned or awarded not by burning biomass for energy that would otherwise be obtained from fossil fuel, but, rather, by fossil fuel replacement (FFR), i.e. preserving carbonaceous material by inhibition of decay that would have otherwise occurred if the material would be passively left to its natural fate.

Thus, according to some embodiments of some aspects of the invention, there is provided a method of inhibiting biodegradation of a biodegradable organic material, the method comprising contacting the organic material with a cytoxic agent or with a solution comprising a cytotoxic characteristic, then concentrating the solution, thereby enhancing cytotoxicity of the solution, and maintaining the biodegradable organic material within the concentrated cytotoxic solution, thereby inhibiting biodegradation of the organic material. In some embodiments, the cytotoxic characteristic is selected from the group consisting of alkalinity, acidity and osmolarity.

According to other embodiments of some aspects of the invention, there is provided a method of inhibiting biodegradation of a biodegradable organic material, the method comprising contacting the organic material with an amount of a cytoxic agent sufficient to produce a cytotoxic environment, and maintaining the biodegradable organic material within the cytotoxic environment, thereby inhibiting biodegradation of the organic material.

According to some embodiments, there is provided a method of inhibiting biodegradation of a biodegradable organic material, the method comprising contacting the organic material with an amount of a salt sufficient for inhibiting biodegradation of the biodegradable organic material and maintaining the biodegradable organic material in contact with the salt, thereby inhibiting biodegradation of said organic material.

According to some embodiments, the salt is provided in a salt solution. In other embodiments, the salt is provided in a salt solution, then the salt solution is concentrated to a produce an environment with salt concentration sufficient to inhibit biodegradation of the biodegradable organic material, and then the biodegradable organic material is maintained within the concentrated salt environment, thereby inhibiting biodegradation of said organic material.

As used herein, the term “salt” refers to a neutral ionic compound of a cation and anion, often a metal with a non-metal. Pure salts are commonly crystalline solids at room temperature, with a greater or lesser degree of solubility in aqueous solvents, dissociating to form solutions comprising ions of the component cation and anions. Some common salt-forming cations include, but are not limited to Ammonium, Calcium, Iron, Magnesium, Potassium, Pyridinium, Quaternary ammonium and Sodium. Some common salt-forming anions include, but are not limited to Acetate, Bromide, Carbonate, Chloride, Citrate, Cyanide, Fluoride, Nitrate, Nitrite, Oxide, Phosphate and Sulfate. Common salts suitable for use with the methods of the present invention include, but are not limited to salts comprising the cations Magnesium, Sodium and Potassium, and the anions of Chlorine, Iodine and Bromide.

In some embodiments, the salt is NaCl (Sodium Chloride), and the salt solution is a saline solution. Thus, according to some embodiments, there is provided a method of inhibiting biodegradation of a biodegradable organic material, the method comprising contacting the organic material with a saline solution, concentrating the saline solution to hypersalinity, thereby producing a hypersaline environment, maintaining the biodegradable organic material within the hypersaline environment, thereby inhibiting biodegradation of said organic material.

As used herein, the term “biodegradation” refers to the process of biotic decomposition, or the reduction of matter to simpler forms of matter by living organisms, i.e. biological, rather than purely chemical or physical processes (i.e. abiotic). The products of biodegradation include carbon dioxide and water, from the breakdown of organic carbon compounds ubiquitous in organic material. Organisms commonly responsible for biodegradation of organic matter include, but are not limited to bacteria and fungi- more complex life forms are also involved in the overall process of biodegradation, such as grazing and burrowing animals. As used herein, the term “biodegradable organic material” refers to material or matter that is composed of organic compounds that come from the remains of plants and animals and their waste products in the environment- mostly existing in the form of cellulose, tannin, cutin, lignin and other proteins, lipids and carbohydrates.

The biodegradable organic material can be in the form of a solid (e.g. wood, solid animal waste), in the form of a liquid (bacterial cultures, liquid waste) or a combination of liquid and solid, such as a slurry (e.g. sewage, industrial and agricultural effluents, etc).

The methods described herein are suitable for inhibiting the biodegradation of a wide range of organic biodegradable materials. Such organic biodegradable material suitable for use with the methods can include, but is not limited to discarded paper and plastic, hospital waste, biotechnology industry waste (for example, from tissue culture and bioreactor processes), municipal waste (e.g. sewage), industrial waste, agricultural waste (for example, field runoff, irrigation effluent etc), aquaculture waste, live and dead/decaying vegetation, organic building materials, and the like.

As used herein, the term “inhibiting biodegradation” refers to reducing the rate and/or efficiency of conversion of biodegradable organic material to a state comprising carbon dioxide and water. Biodegradation can be measured by the production of carbon dioxide per mass of biodegradable material, per unit time.

Thus, increasing the amount of time required to degrade the biodegradable material to carbon dioxide, or reducing the amount of biodegradable material converted to carbon dioxide are both considered a measure of inhibition of biodegradation. In some embodiments the biodegradation is inhibited 1-90, 7-85, 11-83, 15-80, 17-75, 20-70, 25-65, 30-60, 35-55, 40-50, 1, 2, 5, 10, 15, 20, 25, 30, 35, 40, 45, 50, 55, 60, 65, 70, 75, 80, 85, 90% or more of biodegradation of the same biodegradable organic material when left exposed without inhibition to the effects of breakdown by living organisms, for example, the decay of timber in a natural forest. Inhibition of biodegradation by the methods described herein can also be quantified and/or assessed by comparing biodegradation of the organic material(s) under the same, or similar conditions, with and without cytotoxic agent(s), as well as with or without the salts or hypersaline environment and with or without enhancing the cytotoxicity of the cytotoxic agent or salinity of the environment by concentration.

As used herein, the term “cytotoxic agent” refers to a compound, character or an environmental parameter which causes significant reduction or cessation of life processes in an exposed organism or the cells thereof. Cytotoxicity can be assessed by monitoring the proportion of viable organisms or cells persisting following exposure of the biodegradable material to a cytotoxic agent, usually adjusted for a particular concentration of the cytotoxic agent(s).

One common measure of cytotoxicity is the LD50, median lethal dose, or 50% of the minimal lethal dose (killing all of the cells in the assay) of the agent. Many assays are available to measure the viability of cells or populations of cells, such as cell membrane integrity (vital dyes and cell component release, such as LDH assay), live cell protease assays, neutral red uptake (NRU) assays, tetrazolium salt assays (MTT, XTT, MTS, WST) and fluorescent dye resazurin assays, sulforhodamine B (SRB) and clonogenic assays, combinations such as LDH-XTT-Neutral Red assays, and electric impedance measurements.

Cytotoxic agents suitable for use with the methods described herein include, but are not limited to toxins/poisons (such as, but not limited to heavy metals, highly reactive ions such as the halogens, uncouplers of energy metabolism for eukaryote cells—e.g. 2,4 DNP, CCCP, FCCP and beta-lactam and other antibiotics for bacteria), heat, cold, high dose radiation, alkalinity, acidity and hyper- or hypo-osmolarity. It will be appreciated that the cytotoxicity of any particular agent or characteristic is relative to the target organism—for example, most bacteria and other microorganisms cannot withstand heat greater than 150° C. (steam autoclave), but some fungal spores remain viable at that temperature.

A benchmark measure of cytoxicity for hypersaline solutions is 35 percent salt, which represents a lethal environment to most known life forms.

In some embodiments, the cytotoxic agent or characteristic is alkalinity. As used herein, the term “alkalinity” refers to the capacity of a solution to neutralize an acidic solution. Alkaline solutions are commonly called “bases” or “basic solutions”, and have a pH above 7.0. Alkalinity or alkaline solutions can be cytotoxic due to their ability to disrupt and dissolve membranes (they saponify the fatty acids of membranes) and other tissue components. Highly alkaline substances (lye, caustic soda) may cause fatal damage if ingested, and mildly alkaline materials can be used as disinfectants.

In some embodiments, the cytotoxic agent is heavy metal. As used herein, the term “heavy metal” refers to heavy metals most commonly associated with poisoning: lead, mercury, arsenic and cadmium, however. other metals such as bismuth, chromium, cobalt, copper iron, manganese, nickel, selenium, silver, thallium and zinc are also known to be cytotoxic.

With regard to heavy metals, it will be appreciated that inclusion of heavy metals in the methods of the present invention, while providing cytotoxic conditions for inhibiting the biodegradation of biodegradable organic matter and sequenstration of carbon, can in addition serve to sequester the cytotoxic heavy metals themselves. Maintenance of the biodegradable organic material within the cytotoxic and/or hypersaline environment, if isolated from currents or contact with fresh or ocean water reserves and reservoirs, can also result in isolation of cytotoxic agents such as heavy metals.

In some embodiments, the cytotoxic agent or characteristic is hyper- or hypo-osmolarity. As used herein, the term “osmolarity” refers to the proportion of a solute to solvent in a solution—for example, the concentration of salt or sugar in a salt or sugar solution. Osmolarity is technically defined as the concentration of a solution expressed as the total number of solute particles per liter solution.

Solutions with relatively high osmolarity (hyperosmolar) can be cytotoxic due to the inequality of concentration of the solvent (water) on the inside and on the outside of a cell or cells of an organism exposed to a solution having high osmolarity-leading to loss of water and dehydration of the cells. Thus, salting of meats and vegetables, and mixing of fruits with sugar to produce preserves prevents bacterial and fungal overgrowth by maintaining the meats, vegetables and fruits in an environment of high osmolarity. Low osmolarity (hypo-osmolarity) can also be disruptive for cells and living organisms, causing an influx of fluids (water) and loss of solutes (salts, etc) from the cells, potentially leading to swelling and disruption of the cell membrane.

In some embodiments, the cytotoxic agent is a salt. Salts of many metals (e.g. copper, magnesium, calcium, potassium) can be cytotoxic, to some organisms and in suitable concentrations and/or combinations. In some embodiments, the salt is NaCl, and the cytotoxic characteristic is salinity, and the method comprises contacting the organic material with a saline solution, concentrating the saline solution to hypersalinity, thereby producing a hypersaline environment, and maintaining the biodegradable organic material within the hypersaline environment, thereby inhibiting biodegradation of the organic material.

As used herein, the term “saline” refers to an aqueous solution containing a significant amount of dissolved NaCl. Normal saline (or physiological or isotonic saline), similar to the salt concentration of blood, comprises 0.9% NaCl (9.0 grams per liter), and has an osmolarity of 308 mOsmol/liter. Seawater (oceanwater) is typically 3.5% (35 g/liter) NaCl, and many naturally salty bodies of water exist, especially in arid or semi-arid regions. It will be noted that seawater, and the saline water of all hypersaline lakes, while comprising NaCl, also comprises often significant quantities of other metal and non-metal ions, such as, but not limited to magnesium, vanadium, sulfur, calcium, potassium, iodine and bromine.

Thus, in some embodiments, saline solutions suitable for use with the present invention comprise, in addition to NaCl, other metal and non-metal ions such as but not limited to magnesium, vanadium, sulfur, calcium, potassium, iodine and bromine. As used herein, the term “hypersaline” refers to an environment or an aqueous solution having saline levels surpassing those of seawater (i.e. >3.5% salinity or >35 g/liter NaCl). In some embodiments, the salinity of the hypersaline environment or solution is in the range of NaCl4-50% (40.0-500 g/l NaCl), 5-45% (50-450 g/l NaCl), 6-40% (60-400 g/l NaCl), 8-35% (80-350 g/l NaCl ), 10-30% (100-300 g/l NaCl), 12-28% (120-280 g/ NaCl), 14-25% (140-250 g/l NaCl), 15-25% (150-250 g/l NaCl), 16-22% (160-220 g/l NaCl) and 18-21%(180-210 g/l NaCl). In some embodiments, the hypersaline environment or solution has the NaCl concentration in a range of greater than 3.5% (35g/l) to 35% (350 g/l) (i.e. from any concentration >3.5% to a concentration of 35%). In some embodiments, the hypersaline environment or solution has the NaCl concentration of a saturated saline solution, e.g. 26% (260 g/l NaCl) in water at 20° C. In some embodiments the hypersaline environment comprises a super-saturated salt solution (e.g. >26% NaCl).

As used herein, the term “high salt” refers to salt concentrations greater than those of normal physiological conditions. A high salt environment or solution refers to an environment or solution having salt concentrations surpassing those of normal physiological conditions (these may vary with the salt and the organism). In some embodiments, the high salt environment or solution is in the range of 4-50% (40.0-500 g/l salt), 5-45% (50-450 g/l salt), 6-40% (60-400 g/l salt), 8-35% (80-350 g/l salt), 10-30% (100-300 g/l salt), 12-28% (120-280 g/l salt), 14-25% (140-250 g/l salt), 15-25% (150-250 g/l salt), 16-22% (160-220 g/l salt) and 18-21%(180-210 g/l salt).

In some embodiments, the high salt environment or solution has the salt concentration in a range of greater than 3.5% (35 g/l) to 35% (350 g/l) (i.e. from any concentration >3.5% to a concentration of 35%). In some embodiments, the high salt environment or solution has a salt concentration of a saturated salt solution. In some embodiments the high salt environment comprises a super-saturated salt solution.

The high salt or hypersaline environment can be a liquid high salt or hypersaline environment, a solid salt or hypersaline environment, or a combination of the two. Thus, in some embodiments, the high salt or hypersaline environment comprises a high salt or hypersaline solution and solid salt. In some embodiments, the high salt or hypersaline environment comprises 5-90%, 10-85%, 15-80%, 20-75%, 25-70%, 30-65%, 35-60%, 40-55%, greater than 10%, greater than 20%, greater than 30%, greater than 35%, greater than 40%, greater than 45%, greater than 50%, greater than 60%, greater than 65%, greater than 70%, greater than 75%, greater than 80%, greater than 90% (v/v) solid salt. Such a combination of solid salt and salt solution can be a slurry, wherein the solid and liquid components are mixed relatively evenly, or an uneven mixture of the solid and liquid components.

In some embodiments of the present invention, inhibition of degradation is effected by contacting the biodegradable organic material with a solid cytotoxic agent and/or solid salt, sufficient to inhibit the materials' biodegradation, and maintaining the biodegradable organic matter within a cytotoxic or high salt (e.g. hypersaline) environment.

In some embodiments of the present invention, inhibition of the biodegradation is effected by concentrating the cytotoxic agent, salt solution or saline solution after contact with the biodegradable organic matter before maintaining the biodegradable organic matter within a cytotoxic or hypersaline environment. In some embodiments, concentration of the cytotoxic agent or saline solution can be effected by evaporation, by leaching (including upward, downward and sideward leaching), and/or by absorption of fluid (e.g. water) through a membrane (e.g. reverse osmosis).

In some embodiments, concentration by evaporation can be effected naturally, for example, by exposing the biodegradable organic material after contacting with the cytotoxic agent or saline solution to climatic conditions suitable for evaporating liquid from the cytotoxic agent or saline solution, or from the biodegradable organic material itself.

Such conditions can be found in regions having hot and/or dry weather, for example, within the vicinity of deserts and in particular, near hypersaline lakes such as the Dead Sea in the Rift Valley in Israel.

In some embodiments, the biodegradable organic material is transported to a climate suitable for concentration of the cytotoxic agent or saline solution by evaporation, and the contacting with the cytotoxic agent or saline solution is effected at the site of concentration (i.e. by evaporation). For example, organic industrial, urban and/or agricultural waste from the coastal plains of Israel can be transported by road or rail to the Dead Sea region, contacted there with the cytotoxic agent or saline solution and exposed to the low humidity and high temperatures characteristic of the Dead Sea region in order to concentrate the cytotoxic agent or saline solution. In other embodiments, the biodegradable organic material is contacted with the cytotoxic agent or saline solution prior to or during transport to the site of concentration. In one embodiment, the biodegradable organic material is mixed with the cytotoxic agent or saline solution and transported as a slurry to the site of concentration.

Inasmuch as the region of a salt lake, such as the Dead Sea in Israel is often lower in elevation than the surrounding terrain, the difference in elevation can be used for efficient transport of the biodegradable organic material to the region of (or similar to that of) the salt lake for concentration by evaporation. Similar to the proposed Mediterranean-Dead Sea (Med-Dead) or Red Sea-Dead Sea (Red-Dead) canal projects, for example, the flow of a slurry or reduced volume (chopped, mulched, etc) of biodegradable organic material down the elevation gradient (for example, from the cities and towns of the coastal plains of Israel to evaporation sites in the Dead Sea region) can be harnessed to produce power (e.g. electricity), further reducing the use of fuel and carbon emissions.

In some embodiments, concentration of the cytotoxic agent or saline solution after contacting with the biodegradable organic material is effected through investment of energy in place of, or in addition to evaporation resulting from exposure to the ambient climate at the site of concentration. Concentration can be effected by application of thermal energy (heating the cytotoxic agent or saline solution and biodegradable organic material mixture to evaporate the fluids), and/or application of mechanical energy (e.g. centrifugation of the mixture or pressure on the cytotoxic agent or saline solution and biodegradable organic material mixture to force fluid (water) out through a selective membrane which retains the biodegradable organic material, thereby concentrating the cytotoxic agent or saline solution and biodegradable organic material mixture).

In some embodiments, solar energy is used to effect concentration of the cytotoxic agent or saline solution and biodegradable organic material mixture. Solar energy can be used in a variety of ways suitable for application to the present invention, for example, by photovoltaic conversion of solar to electrical energy, which can then be converted to thermal or mechanical energy, and/or by direct or indirect application of solar thermal energy to the cytotoxic agent or saline solution and biodegradable organic material mixture. Solar energy can be ambient solar energy or can be concentrated by reflecting panels and/or mirrors.

The addition of a dark color to the biodegradable organic material or to the fluid in contact with it and/or its container may enhance the transfer of solar thermal energy to the biodegradable organic material upon exposure to the sun, thereby enhancing the concentration (by evaporation) as well as enhancing the inhibition of biodegradation of the material. It is possible to reduce the amount of area needed by a large factor and/or enhance the evaporation rate in less arid climates if the saline solution is warmed by sunlight, for then the evaporation rate rises considerably.

The temperature of the water could be raised to well above average ambient air temperature if it is seeded with photoabsorbent substances, such as charcoal. The carbon waste itself may in some cases enhance sunlight absorption, especially if slightly charred. In this case, far less than 15 square meters per person is required to store the carbon in the amounts that the world burns it at present. Thus, in some embodiments, the cytotoxic agents and/or saline solutions further comprise added photoabsorbent pigments. Photoabsorbent pigments suitable for use with the present invention include, but are not limited to charcoal, dark-pigmented paint, graphite, natural (e.g. vegetable) pigments and the like.

In some embodiments, concentration is effected by leaching of fluids from the cytotoxic agent or saline solution and biodegradable organic material mixture or directly from the biodegradable material. Leaching of fluids can be effected by contacting (e.g. layering) drier combinations or mixtures of cytoxic agent and biodegradable organic material with combinations having greater fluid content, and concentration through loss of fluids to the drier combination or loss of fluid to the exteriors of both the biodegradable material and the cytoxic agent.

For example, placing salt on many forms of biomass will cause fluid to drain out of the biomass and flow away from it. In one embodiment, the drier mixture or mixtures are layered over the more fluid-rich mixtures, and fluids are leached upwards, thereby concentrating the cytotoxic agent or saline solution and biodegradable organic material mixture. However, leaching of fluids from mixtures of the cytotoxic agent or saline solution and biodegradable organic material can occur in any relative direction (the leaching may for example be downward or sideward as well), and will always take place in the direction of the gradient, i.e. from a higher fluid content (lower solute content) towards the lower fluid (higher solute content) content.

In order to effectively prevent, or inhibit biodegradation of the biodegradable organic material, the biodegradable organic material can be maintained within a cytotoxic, high salt and/or hypersaline environment. In one embodiment, such a hypersaline environment can be maintained at the site of addition of, or concentration of the cytotoxic agent, salt or saline solution and biodegradable organic material mixture. In another embodiment the hypersaline environment can be maintained remotely from the site of concentration. Understandably, it may be energetically advantageous to maintain the cytotoxic, high salt and/or hypersaline environment at the site of concentration, without need to further transport the mixture following concentration.

Thus, in some embodiments of the method of the present invention, the concentration is effected in an evaporating pan or pond. Evaporating pans, also called salterns or salt pans, such as those at the Dead Sea Works in Israel, Salinas de Chiclana in Spain or the Salterns of Guerande, Brittany, France are traditionally shallow artificial ponds used to extract salts from sea water or other brines. The seawater or brine is fed into large ponds and water is drawn out through natural evaporation which concentrates the salt(s) (allowing it to be harvested). The pans or ponds are commonly separated by levees. The evaporation pans or ponds can be artificial (man-made) or natural salt pans, (geological formations that are created by water evaporating). Evaporating pans or ponds may be of any suitable size, and may be fashioned from any material which can be shaped into a shallow container.

Where leakage of fluid and organic material must absolutely be precluded, the evaporation pan or pond may be constructed from of a non-porous, water-impermeable material. However, evaporation pans or ponds constructed from porous materials are also envisaged. In addition, in order to prevent undesired introduction of moisture and/or material into the evaporation pond or pan, a protective barrier (e.g. clothe, plastic sheeting, metal, etc) can be fitted over the evaporation pan.

As used herein, the term “evaporation pan”, or “evaporation pond” refers to a shallow enclosure in which the mixture of cytotoxic agent or saline solution and biodegradable organic material may be concentrated by evaporation. In some embodiments, the evaporating pan or pond may be physically contiguous with a natural source of salts, saline (or hypersaline) or cytotoxic fluid (solution), such as an evaporating pan within or near a salt lake such as the Dead Sea, or at a coastal area (sea shore).

In yet other embodiments, biodegradable organic material can be deposited on or near the shore of a salt lake or at or near the seashore, contacted with the saline waters of the ocean or salt lake in a shallow area. In yet other embodiments, channels are constructed to allow the oceans' or lakes' waters to flow towards and mix with the biodegradable organic material, and an evaporation pan is created by enclosing the biodegradable organic material in a system of dikes or levees and sealing the area from the surrounding ocean or waters of the lake. Thus, in such embodiments, the salts, cytotoxic agents, saline (or hypersaline) or cytotoxic fluid (solution) need not be transported to the evaporation site.

In other embodiments, the evaporating pan or pond is physically separate from the natural source of salts, cytotoxic agents, saline (or hypersaline) or cytotoxic fluid (solution), i.e.—both the biodegradable organic material and the salts, cytotoxic agents, saline (or hypersaline) or cytotoxic fluid (solution) need to be transported to the site of concentration for evaporation. In some embodiments the evaporating pan or pond is located near but not within a natural source of salts, cytotoxic agents, saline (or hypersaline) or cytotoxic fluid (solution).

In some embodiments, the evaporation pan or pond is enclosed by solid or solidifying salt, and the mixture of cytotoxic agent or salt (e.g. saline) solution and biodegradable organic material is introduced into the pan or pond for concentration of the cytoxic agent or salt. In some embodiments, following concentration and achievement of a hypersaline or toxic environment the now concentrated mixture becomes the upper surface of the evaporating pan or pond. In such a manner, successive amounts of mixtures of cytotoxic agent or saline solution and biodegradable organic material are concentrated and become successive layers of the hypersaline or cytotoxic environment below the upper surface of the evaporating pond or pan.

In some embodiments, additional mixture of cytotoxic agent or saline solution and biodegradable organic material can be introduced to the evaporating pan or pond above the now concentrated mixture (the upper surface of the pond or pan). In other embodiments, the biodegradable organic material and the cytotoxic agents, salts and/or cytotoxic or salt solutions are provided separately to the evaporation pan, and then mixed or contacted within the evaporation pan for evaporation.

In other embodiments, following evaporation and concentration in an evaporating pan or pond, the concentrated, hypersaline or cytotoxic mixture of cytotoxic agent or saline solution and biodegradable organic material is removed from the evaporating pan or pond and deposited in a separate location, constituting therein the hypersaline or cytotoxic environment suitable for inhibiting or preventing biodegradation of the biodegradable organic material.

It will be appreciated that, in order to inhibit biodegradation, the methods and systems of the present invention require direct contact of the biodegradable organic material with the cytotoxic agent or saline solution. This differentiates the methods and systems of the present invention from well-known methods for sequestration and disposal of waste, particularly radioactive or toxic waste, or sequestration of CO₂ within salt mines, deposits or mounds, where the salt deposits serves to isolate the sequestered material from the hydrosphere, atmosphere and biosphere for long periods of time, is chosen mainly for its geological stability, and where the sequestered material (particularly radioactive waste) is often deposited within sealed and well insulated containers. Thus, in some embodiments the biodegradable organic material is in direct contact with the cytotoxic agents and/or saline solution.

In some embodiments, following addition of cytotoxic agents and/or salts, or concentration of the cytotoxic agents or saline solution and attainment of cytotoxic or hypersaline environment and conditions for inhibition of biodegradation of the biodegradable organic material, the mixture of cytotoxic agents and/or high salt (e.g. hypersaline) solutions and biodegradable organic material may be covered or even sealed, in order to maintain the cytotoxic or hypersaline environment and conditions for inhibition of biodegradation of the biodegradable organic material and minimize interaction with the environment.

Thus, in some embodiments the method of the present invention further comprises covering the biodegradable organic material with a solid or semi-solid sealing material. Suitable sealing materials include, but are not limited to clay, ice, plastic, wood, glass and solid salt. Deposition of successive layers of the mixture of cytotoxic agents or hypersaline solutions and biodegradable organic material, separated by the semi-solid or solid sealing material is envisaged. Where the method of the present invention is performed in an evaporation pan or evaporation pond, in some embodiments the bottom of the evaporation pan or pond comprises a layer of solid or semi-solid material covering the biodegradable organic material within the cytotoxic or hypersaline environment.

In some embodiments, the biodegradable organic material is pre-treated prior to the step of contacting with the cytotoxic agents, salts and/or salt (e.g. saline) solution, in order to enhance and/or facilitate the inhibition of biodegradation of the organic material. For example, in some embodiments, the biodegradable organic material is exposed to a cytotoxic agent, salt or treatment prior to contacting with the cytotoxic or salt (e.g. saline) solution. Such a treatment or pretreatment can be advantageous to the method for inhibiting biodegradation of organic material, for example, by killing living organisms within the bulk of the biodegradable material prior to contact with cytotoxic agent, salt or solutions, obviating the need for sterilizing the interior of the bulk and require sterilization by salt of only the periphery of the biodegradable organic materials, where there is the risk of renewed exposure to ambient organisms.

When considered in view of the possibility of future exposure to biodegrading organisms, such a treatment or pretreatment, although it might not of itself constitute large scale inhibition, has the potential to greatly reduce the amount of cytotoxic agent, salt or salt or cytotoxic solutions needed to permanently inhibit biodegradation of a given quantity of biodegradable organic material. In some embodiments, the biodegradable organic material is exposed to heat prior to contacting with the cytotoxic agent or saline solution.

In some embodiments, the biodegradable organic material is exposed to heat, and heated to microbiocidal temperatures for a duration sufficient to kill, or damage biodegrading (e.g. microbial) organisms within the biodegradable organic material. It will be appreciated that the energy required to heat a given quantity of biodegradable material to 100 degrees Centigrade, enough to sterilize its bulk, is far less than the energy that could be obtained were the biodegradable material converted to biofuel and combusted. In some embodiments, the biodegradable organic material is reduced prior to contacting with the cytotoxic agent, salt and/or cytotoxic or saline solution.

In some embodiments, the biodegradable organic material is exposed to a toxic agent prior to contacting with the cytotoxic agent, salt and/or cytotoxic or saline solution. In this regard, it will be appreciated that sterilization of any given quantity of biodegradable material by irradiation or freezing requires far less energy than could be obtained by the burning of the biomass.

In some embodiments, the hypersaline environment can be effected by mixing or coating the biodegradable organic material with solid (e.g. crystalline, pulverized) salt, rather than contacting with a saline solution. In such an embodiment, the need for concentrating the saline solution may be eliminated, if, for example, sufficient solid salt can be added to or contacted with the biodegradable organic material to inhibit biodegradation. Maintenance of the high salt (e.g. hypersaline) environment following contact of the biodegradable organic material with the solid salt can be effected in the same manner as with methods described herein requiring saline solution and concentration of the saline solution to hypersalinity.

Advantages of inhibiting biodegradation of the biodegradable organic material with salt can be demonstrated by the following comparison between the energy investment required for extracting salt from ocean waters (by evaporation) vs. the use of the same water for producing hydroelectric power.

1 kilogram of seawater lowered by one meter in the Earth's gravitational field releases 9.8 joules of energy. Hydroelectric power from an elevation differential of 400 meters (e.g. a “Red Sea-Dead Sea” or a “Mediterranean Sea-Dead Sea” canal), can produce 3920 joules per kilogram of water, or 0.92 kilocalorie (i.e. nearly one “food” calorie. One food calorie =4184 joules). On the other hand, the same one kilogram of seawater, if dried and/or concentrated by evaporation, yields 30 grams of salt.

Assuming that, conservatively, 30 grams of salt could preserve at least 30 grams of carbon, and considering that 30 grams of carbon, if burned, would yield 270 kilocalories, the salt byproducts of any hydroelectric plant that channeled sea water to an altitude below sea level could inhibit or prevent the release of the equivalent of 270 kilocalories, or about 300 times as much carbon in biomass as the fossil carbon (whose burning would be) spared (equivalent of 0.92 kilocalories per kg of salt water) by the hydroelectric energy produced.

Further, inasmuch as contact with solid salt tends to leach fluids from biodegradable organic material, inhibiting biodegradation of the biodegradable organic material by contact with solid salt and maintenance in a high salt (e.g. hypersaline) environment can also effectively reduce the volume of the biodegradable organic material, thereby reducing the volume of space required while maintaining inhibition of the biodegradation of the biodegradable organic material.

To this end, additional treatment of the biodegradable organic material following contact with a cytotoxic agent, salt or salt solution, and then prior to or following the step of concentrating the solutions, where applicable, may include, but is not limited to, chipping, mulching, pulverizing, crushing, compressing, withdrawing air (e.g. by vacuum), flattening, etc the biodegradable organic material in order to further maximize contact between the salt, saline solution and/or cytotoxic agent, and minimize the volume of the biodegradable organic material required for maintenance of the hypersaline or cytotoxic environment and storage.

In some embodiments, inhibiting the biodegradation of biodegradable organic material comprises drying biodegradable organic material rather than, or in addition to contacting with a salt, salt (e.g. saline) solution or cytotoxic agent. In such an embodiment, the need for contact with an external source of saline solution, cytotoxic agents and/or salt, and even concentrating solutions may be reduced or eliminated, if, for example, reduction of fluid volume by drying (e.g. evaporation) acts to concentrate constituents of intra-cellular and extracellular fluids sufficiently to create an environment in which degradation of biodegradable organic material is inhibited.

Drying can be effected by passive exposure to arid climatic conditions (low humidity and/or high temperatures and/or sunlight) and/or air currents (windy conditions), and/or artificially enhanced climatic conditions, for example, application of thermal energy (heating), dehumidification and/or production or intensification of air currents.

It will be appreciated that a drying step can be added to any one of the methods for inhibiting the biodegradation of biodegradable organic material described herein, and, where suitable, at any point during the course of the methods. Maintenance of the high salt (e.g. hypersaline) environment following contact of the biodegradable organic material with the solid salt can be effected in the same manner as with methods described herein requiring saline solution and concentration of the saline solution to hypersalinity.

The methods of the present invention can be used to inhibit biodegradation of biodegradable organic material. Thus, according to some embodiments of the invention, there is provided a system for inhibiting biodegradation of biodegradable organic material comprising an evaporation pan, a saline solution source, biodegradable organic material and a means for concentrating the saline solution in the evaporation pan, wherein the evaporation pan is designed to allow contacting the biodegradable organic material in the saline solution, and the means for concentrating the saline solution is designed to allow concentrating the saline solution within the evaporating pan with the biodegradable organic material. In some embodiments, the evaporation pan, saline solution source and means for concentrating the saline solution are natural.

One non-limiting example of such a system may be a system for the sequestration of biodegradable organic material in evaporation pans within the greater Dead Sea area or that of other hypersaline lakes, such as to utilize the same geological conditions that gave rise to the hypersalinity of the lakes. Biodegradable organic material, such as, but not limited to agricultural, urban or industrial waste may be transported as a solid, by road or rail, or as a slurry, by a canal or similar conduit from the surrounding area down an elevation gradient to evaporation pans within the greater Dead Sea area. The evaporation pans or ponds can be designed to receive high salinity saline solution from the hypersaline lake, to allow contacting the biodegradable organic material with the saline solution. In other embodiments, evaporation pans or ponds can be designed to receive water of low or medium salinity or other salt content, which can be further concentrated into higher salt concentration by evaporation.

Once contacted, the high salt (e.g. hypersaline) and/or cytotoxic solution can be further concentrated by evaporation by exposure to the heat and dryness of the Dead Sea climate. In some embodiments, additional means for concentrating the salt solution such as, but not limited to circulation of the air or fluids in the evaporating pan, additional thermal energy and the like may be employed, to achieve a hypersaline environment suitable for inhibition of biodegradation of the biodegradable organic material.

Once a high salt (e.g. hypersaline) environment is achieved, effectively inhibiting biodegradation of the biodegradable organic material in the mixture of biodegradable organic material and salt and/or cytotoxic agent solution, the biodegradable material can then either be sealed within the hypersaline environment (e.g. by a layer of salt or other sealing material) or serve itself as the upper surface of the evaporation pan, which can then receive additional biodegradable organic material and saline solution, and be subject to concentration.

Sequestering and inhibiting biodegradation of biodegradable organic matter, including dehydration and compactification of the biodegradable organic matter using the methods and systems of the present invention can possibly mimic the geological conditions which produced the reserves of “fossil fuel” which supply the main modern source of energy.

Thus, also envisaged within the context of the methods and systems of present invention is a method for producing carbonaceous combustible “fossil fuel” by inhibiting biodegradation of biodegradable organic material according to the methods and systems of the present invention and storing the biodegradable organic matter, optionally with additional agents and/or under preserving conditions for more than 3 years, or optionally more than 10 years, or optionally, more than 20 years, or optionally, more than 30 years, or optionally more than 50 years, or optionally, more than 100 years, or optionally more than 300 years, or, optionally, more than 1000 years, optionally rinsing out the preserving agents and/or changing the conditions as needed to render the stored biodegradable organic material fit for combustion, consumption, or other immediate usage. It will be appreciated that such fuel would be more compact and/or less hydrated than in the original state of the biomass, and thus more easily and inexpensively transported.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998);

methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, Conn. (1994); Mishell and Shiigi (eds), “Selected Methods in Cellular Immunology”, W. H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., ed. (1984); “Nucleic Acid Hybridization” Hames, B. D., and Higgins S. J., eds. (1985); “Transcription and Translation” Hames, B. D., and Higgins S. J., eds. (1984); “Animal Cell Culture” Freshney, R. I., ed. (1986); “Immobilized Cells and Enzymes” IRL Press, (1986); “A Practical Guide to Molecular Cloning” Perbal, B., (1984) and “Methods in Enzymology” Vol. 1, 2, 317, Academic Press; “PCR Protocols: A Guide To Methods And Applications”, Academic Press, San Diego, Calif. (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader. All the information contained therein is incorporated herein by reference.

### EXAMPLE I

### Effect of A Hypersaline Environment on Biodegradation of Organic Material

Biodegradation of biodegradable organic material, in the presence and absence of hypersaline conditions was compared, by assaying CO₂ emission.

A: Grape Juice

Methods: Grape juice was placed in test tubes, and salt added to one of the samples in excess of saturation (undissolved salt remained visible). The volume ratio of fluid to air was about 1:2, in rough correspondence to the ocean and atmosphere. The ratio of organic material to water and air was deliberately much larger than that of the biosphere so that CO₂ production would be within an easily detectable range. The test tubes were sealed after several days to allow measurement of emitted CO₂. The gas phase of the test tubes was analyzed using a Gas Chromatograph Mass Spectrometer.

Results: In the unsalted sample, most of the oxygen had been converted to CO₂ while, in the salt-saturated sample, both the oxygen and CO₂ levels were substantially unchanged from their initial levels, while correcting for the effect of salinity on gas solubility in the liquid (Reduction in solubility of, and release of CO₂ with increasing salt concentration).

B: Pumpkin

Methods: Solid pieces of pumpkin were placed in unsalted drinking water and in a saturated sea salt solution. They remained exposed to circulating (ambient) air.

Results: Those samples of pumpkin maintained in the control (unsalted) sample decayed and lost their geometric form within days. Samples maintained in saturated sea salt solution maintained their geometric form for at least one year (still under observation). One possible interpretation is that at least the cellulose fiber structure of the pumpkin has been preserved by maintenance in the salt solution. Further, whereas the organic material (pumpkin) floated in the saturated salt sample at first, the samples eventually sank, suggesting that the specific gravity of the biodegradable organic material increased with time.

Solid pieces of pumpkin were also placed in a saturated sea salt solution and then removed after soaking for several days and left in a salt-encrusted state. They, and a control group of untreated pumpkin pieces, were then maintained in sealed test tubes. The unsalted ones showed loss of geometric form and visible growth of mold, while the salt-encrusted samples had no evidence of loss of geometric form or mold growth over many months.

What is claimed is:

1. A method of reducing greenhouse gas emissions comprising:
(a) contacting biodegradable organic material with oceanwater;
(b) transporting said biodegradable organic material and said oceanwater to a hypersaline lake;
(c) concentrating said oceanwater, thereby producing a hypersaline environment; and
(d) maintaining said biodegradable organic material within said hypersaline environment,
wherein steps (b)-(d) are performed within or on the shore of said hypersaline lake, thereby reducing greenhouse gas emissions from degradation of said biodegradable organic material, wherein the water of said hypersaline lake is in the range of 10-40% NaCl and wherein said hypersaline environment comprises 5-90% (v/v) solid salt.

2. The method of claim 1, wherein said hypersaline environment is above sea level.

3. The method of claim 1 wherein said hypersaline lake is above sea level.

4. The method of claim 1, wherein said hypersaline lake is below sea level.

5. The method of claim 1, wherein said concentrating is effected by a method selected from the group consisting of evaporation, leaching, and absorption and/or forcing of fluid through a membrane.

6. The method of claim 1, wherein said biodegradable organic material is selected from the group consisting of discarded plastic and paper, municipal waste, industrial waste, hospital waste, agricultural waste, aquacultural waste, live vegetation and dead vegetation.

7. The method of claim 1, wherein said biodegradable organic material is treated to minimize the volume of the biodegradable organic material, wherein said treating is selected from the group consisting of chipping, mulching, pulverizing, crushing, compressing withdrawing air and flattening.

8. The method of claim 1, wherein step (d) comprises maintaining said biodegradable organic material in direct contact with said hypersaline environment.

9. The method of claim 1, wherein steps (b)-(d) are performed in an evaporation pan comprising non-porous and/or water-impermeable material.

10. A method for producing biodegradable organic combustible fuel comprising:
(a) contacting biodegradable organic material with;
(b) transporting said biodegradable organic material and said oceanwater down an elevation gradient to a hypersaline lake below sea level;
(c) concentrating said oceanwater, thereby producing a hypersaline environment; and
(d) storing said biodegradable organic material within said hypersaline environment,
(e) retrieving said biodegradable organic material from said hypersaline environment,
wherein steps (b)-(d) are performed within or on the shore of said hypersaline lake, thereby producing biodegradable organic combustible fuel, wherein the water of said hypersaline lake is in the range of 10-40% NaCl and wherein said hypersaline environment comprises 5-90% (v/v) solid salt.

11. The method of claim 10, wherein said hypersaline lake is above sea level.

12. The method of claim 10, wherein said hypersaline lake is below sea level.

13. The method of claim 10, wherein said hypersaline environment is above sea level.

14. The method of claim 10, further including removing salt or salt solution from said stored biodegradable organic material, to render it fit for combustion.

15. The method of claim 10, wherein said concentrating is effected by a method selected from the group consisting of evaporation, leaching, and absorption and/or forcing of fluid through a membrane.

16. The method of claim 10, wherein said biodegradable organic material is selected from the group consisting of discarded plastic and paper, municipal waste, industrial waste, hospital waste, agricultural waste, aquaculture waste, live vegetation and dead vegetation.

17. The method of claim 10, wherein said biodegradable organic material is treated to minimize the volume of the biodegradable organic material, wherein said treating is selected from the group consisting of chipping, mulching, pulverizing, crushing, compressing withdrawing air and flattening.

18. The method of claim 10, wherein steps (b)-(d) are performed in an evaporation pan comprising non-porous and/or water-impermeable material.

19. A method of fossil fuel replacement (FFR), the method comprising:
transporting biodegradable organic material and/or a solution of cytotoxic material to a location,
contacting said biodegradable organic material with said cytotoxic material;
concentrating said solution of cytotoxic material in said location until it becomes a cytotoxic environment;
piling and storing said biodegradable organic material in said cytotoxic environment for a period of time, and
rinsing out said cytotoxic material from said biodegradable organic material or changing conditions of said cytotoxic environment to render stored biodegradable organic material fit for combustion.

20. The method of claim 19, wherein said concentrating is effected by a method selected from the group consisting of evaporation, leaching, and absorption and/or forcing of fluid through a membrane.

21. The method of claim 19, wherein said cytotoxic environment is a hypersaline environment.

22. The method of claim 21, wherein said hypersaline environment can be a liquid hypersaline environment, a solid hypersaline environment, or a combination of the two.

23. The method of claim 22, wherein said hypersaline environment comprises 5-90% (v/v) solid salt.

24. The method of claim 19, wherein said biodegradable organic is selected from the group consisting of discarded paper and plastic, municipal waste, industrial waste, hospital waste, agricultural waste, aquaculture waste, live vegetation and dead vegetation.

25. The method of claim 19, wherein said biodegradable organic material is treated to minimize the volume of the biodegradable organic, wherein said treating is selected from the group consisting of chipping, mulching, pulverizing, crushing, compressing withdrawing air and flattening.

26. The method of claim 19, wherein said transporting comprises moving said biodegradable organic material and/or said cytotoxic material down an elevation gradient to a salt lake.

27. The method of claim 19, wherein where said location is enclosed in a system of dikes or levees and sealed from the surrounding ocean or lake.

28. The method of claim 19, wherein said concentrating and said storing are performed in an evaporation pan comprising non-porous and/or water-impermeable material.

29. A method of reducing greenhouse gas emissions, the method comprising:
transporting biodegradable organic material or a solution of cytotoxic material to a location,
contacting said biodegradable organic material with said cytotoxic material;
concentrating said solution of cytotoxic material in said location until it becomes a cytotoxic environment;
piling and storing said biodegradable organic material in said cytotoxic environment, thereby reducing greenhouse gas emissions.

30. The method of claim 29, wherein said concentrating is effected by a method selected from the group consisting of evaporation, leaching, and absorption and/or forcing of fluid through a membrane.

31. The method of claim 29, wherein said cytotoxic environment is a hypersaline environment.

32. The method of claim 31, wherein said hypersaline environment can be a liquid hypersaline environment, a solid hypersaline environment, or a combination of the two.

33. The method of claim 32 wherein said hypersaline environment comprises 5-90% (v/v) solid salt.

34. The method of claim 29, wherein said biodegradable organic is selected from the group consisting of discarded paper and plastic, municipal waste, industrial waste, hospital waste, agricultural waste, aquaculture waste, live vegetation and dead vegetation.

35. The method of claim 29, wherein said biodegradable organic material is treated to minimize the volume of the biodegradable organic, wherein said treating is selected from the group consisting of chipping, mulching, pulverizing, crushing, compressing withdrawing air and flattening.

36. The method of claim 31, wherein said transporting comprises moving said biodegradable organic material and/or said cytotoxic material down an elevation gradient to a salt lake.

37. The method of claim 29, wherein where said location is enclosed in a system of dikes or levees and sealed from the surrounding ocean or lake.

38. The method of claim 29, wherein said concentrating and said storing are performed in an evaporation pan comprising non-porous and/or water-impermeable material.
